(19) United States
(12) Patent Application Publication
(10) Pub. No.: US 2024/0202811 A1
(43) Pub. Date: Jun. 20, 2024

(54) INFORMATION PROCESSING APPARATUS AND INFORMATION PROCESSING METHOD

(71) Applicant: Toshiba Tec Kabushiki Kaisha, Tokyo (JP)

(72) Inventor: Yumiko OKUMA, Koganei Tokyo (JP)

(21) Appl. No.: 18/466,585

(22) Filed: Sep. 13, 2023

(30) Foreign Application Priority Data
Dec. 20, 2022 (JP) 2022-203606

(51) Int. Cl. G06Q 30/0601; G06F 3/0482; G06F 3/04845

(52) U.S. Cl. CPC G06Q 30/0643; G06F 3/0482; G06F 3/04845; G06Q 30/0635

(57) ABSTRACT

According to one embodiment, an information processing apparatus includes a storage unit, a communication interface, and a processor. The processor is configured to cause a display screen to display an operation screen on which operation elements corresponding to a plurality of items are disposed, then receive a selection of an operation element displayed on the operation screen. The processor executes order processing based on the received selection of the operation element if the processor is in a first operating mode and receives an editing operation for changing setting information related to a state of the item corresponding to the selected operation element if the processor is in a second operating mode. The display mode of the selected operation element is set according to the setting information related to the state of the item.

### CROSS-REFERENCE TO RELATED APPLICATION

This application is based upon and claims the benefit of priority from Japanese Patent Application No. 2022-203606, filed Dec. 20, 2022, the entire contents of which are incorporated herein by reference.

### FIELD

Exemplary embodiments described herein relate to an information processing apparatus and an information processing method.

### BACKGROUND

A user interface that allows selection of a commodity via operation elements (buttons, icons, etc.) displayed on a display screen is used for ordering terminals used in restaurants and POS terminals used in large retailers. In the related art, a POS terminal is known which displays a plurality of buttons corresponding to different commodities on a touch panel and allows selection of the commodity assigned to a button by touching the button. Such an information processing apparatus stores a setting file in which the assignments of the commodities to the operation elements are set, and displays the commodity selection operation elements on a screen based on the setting file.

There is additionally a demand to reflect a state of the related commodity in the commodity selection operation elements. For example, when a commodity goes out of stock, it is preferable to edit the setting file to display information such as out-of-stock information on an operation element of the corresponding commodity, thereby prompting a user not to operate the operation element.

However, since the setting file is typically edited using a dedicated application or a dedicated device, the editing operation is complicated, and time may be required until edited content is reflected in the commodity selection operation elements.

### BRIEF DESCRIPTION OF THE DRAWINGS

FIG. 1 is a diagram showing an example of a hardware configuration of an order terminal according to a first embodiment.

FIG. 2 is a table showing an example of a data configuration of a commodity management file.

FIG. 3 is a table showing an example of a data configuration of a display setting file.

FIG. 4 is a diagram depicting a functional configuration of an order terminal.

FIGS. 5 to 11 depict aspects of an operation screen displayed by a display control unit.

FIG. 12 is a flowchart of processing performed by the order terminal.

FIG. 13 is a diagram showing an example of a configuration of an information processing system according to a second embodiment.

FIG. 14 is a diagram depicting a functional configuration of an order terminal.

FIG. 15 depicts aspects of an operation screen displayed by the display control unit.

FIG. 16 is a flowchart of processing performed by the order terminal.

### DETAILED DESCRIPTION

In general, according to one embodiment, an information processing apparatus and an information processing method that provide a technological improvement related to easier editing of settings related to the display of operation elements used for selecting a commodity are described.

According to one embodiment, an information processing apparatus includes a storage unit, a communication interface, and a processor. The processor is configured to cause a display screen to display an operation screen on which operation elements corresponding to a plurality of items are disposed, then receive a selection of an operation element displayed on the operation screen. The processor executes order processing based on the received selection of the operation element if the processor is in a first operating mode and receives an editing operation for changing setting information related to a state of the item corresponding to the selected operation element if the processor is in a second operating mode. The display mode of the selected operation element is set according to the setting information related to the state of the item.

Hereinafter, an information processing apparatus and a program according to certain example embodiments will be described with reference to the drawings. In the example embodiments described below, an order terminal used in a store such as a restaurant will be described, but the present disclosure is not limited to this example.

### First Embodiment

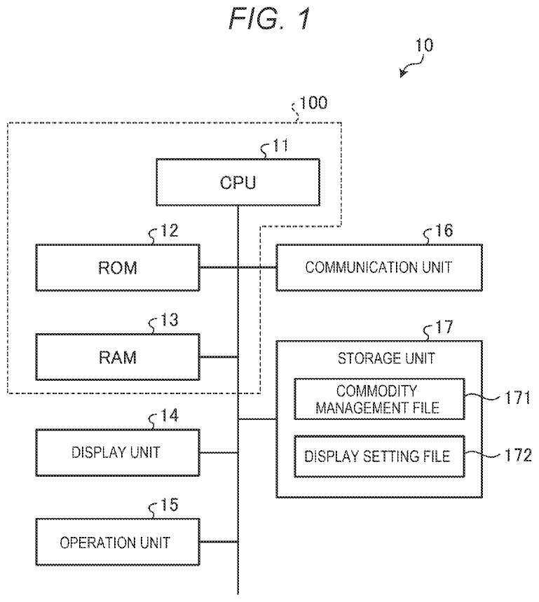

FIG. 1 is a diagram showing an example of a hardware configuration of the order terminal according to a first embodiment. An order terminal 10 is an example of an information processing apparatus. The order terminal 10 is a terminal apparatus used when ordering a commodity (food or drink) in a store such as a restaurant. Examples of the order terminal 10 include a clerk-operated order terminal 10 operated by an employee of the store and a self-service order terminal 10 operated by a customer. In the following description, when these types are not to be distinguished from each other, the types can each be referred to as an “order terminal 10”.

An external configuration of the order terminal 10 is not particularly limited, and may be a portable configuration such as a smartphone or a tablet terminal, or may be a stationary configuration.

As shown in FIG. 1, the order terminal 10 includes a central processing unit (CPU) 11, a read only memory (ROM) 12, and a random access memory (RAM) 13.

The CPU 11 is an example of a processor, and comprehensively controls units of the order terminal 10. The ROM 12 stores various programs. The RAM 13 is a workspace for loading programs and various kinds of data.

The CPU 11, the ROM 12, and the RAM 13 are connected to one another via a bus or the like, and constitute a control unit 100 having a computer configuration. The control unit 100 executes various kinds of processing by the CPU 11 operating according to a program (software) stored in a storage unit 18 and loaded into the RAM 13.

The order terminal 10 includes a display unit 14, an operation unit 15, a communication unit 16, a storage unit 17, and the like.

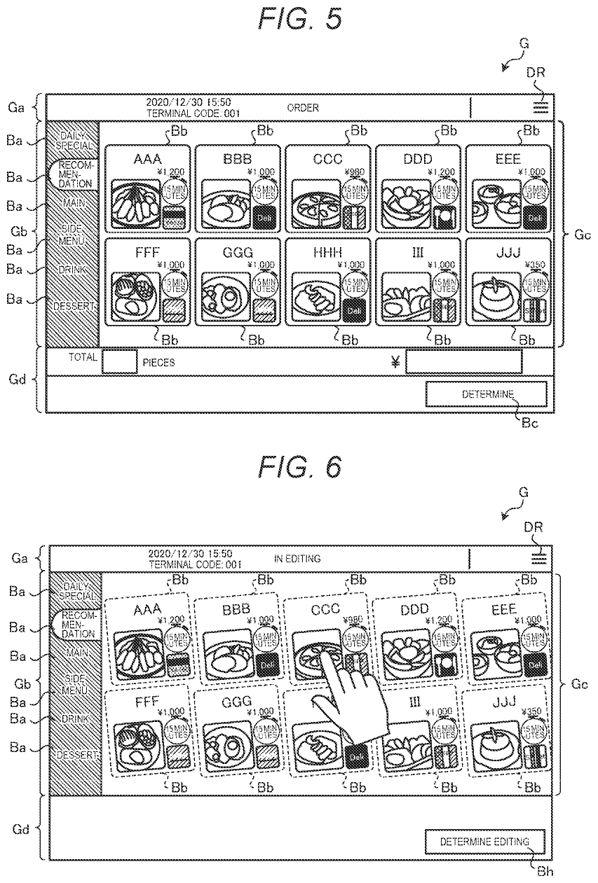

The display unit 14 is a display device such as a liquid crystal display (LCD). The display unit 14 displays various kinds of information under control of the CPU 11. For example, the display unit 14 displays an operation screen (see FIG. 5) for supporting an ordering operation of a commodity (e.g., an item or product for sale at the store).

The operation unit 15 is an input device for receiving inputs from an operator. The operation unit 15 sends inputs (operations) received from the operator to the CPU 11. In the first embodiment, it is assumed that the operation unit 15 is a touch panel provided on a display screen of the display unit 14, but is not limited thereto, and may include a hardware key such as a button or a keyboard, a pointing device, and the like.

The communication unit 16 is a wired or wireless communication interface that can be connected to a network provided in the store. Under the control of the CPU 11, the communication unit 16 is connected to the network, and transmits and receives various kinds of data to and from another apparatus connected to the network (for example, another order terminal 10, a store server, or the like).

The storage unit 17 is an auxiliary storage device such as a hard disk drive (HDD) or a solid-state drive (SSD). The storage unit 17 stores various programs that can be executed by the CPU 11 and various kinds of setting information. Further, the storage unit 17 stores a commodity management file 171 and a display setting file 172.

The commodity management file 171 stores information about commodities. The commodity management file 171 stores information about a commodity (hereinafter, also referred to as commodity information) such as a commodity name, a price, and the like for each commodity sold in the store.

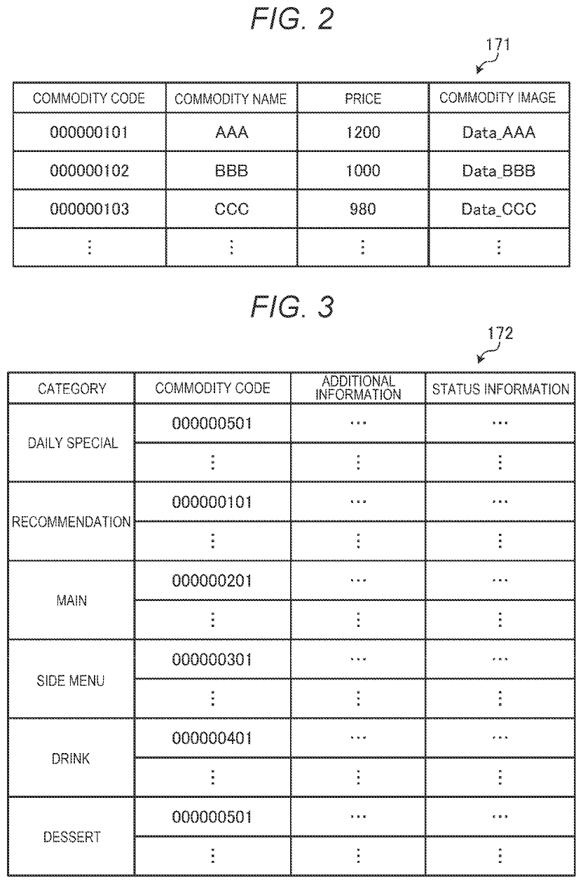

FIG. 2 depicts a table providing an example of a data configuration of the commodity management file 171. As shown in FIG. 2, the commodity management file 171 stores commodity information about a commodity in correlation with a commodity code. The commodity code is an example of commodity identification information that enables identification of a commodity.

The commodity information includes, for example, a commodity name, a price, a commodity image, and the like. The commodity name is information indicating a name of a commodity corresponding to a commodity code. The price is information indicating a price of the commodity corresponding to the commodity code. The commodity image is image data representing the commodity corresponding to the commodity code.

In the first embodiment, the order terminal 10 stores the commodity management file 171, but the present disclosure is not limited thereto, and another device accessible by the order terminal 10 (for example, a store server) may store the commodity management file 171.

The display setting file 172 stores settings related to display of an operation screen (see FIG. 5 and the like). Specifically, the display setting file 172 stores information for defining a relationship between an operation element used for selecting a particular commodity (a commodity selection button Bb) that is displayed on the operation screen and the commodity associated with operation of the operation element.

FIG. 3 is a table showing an example of a data configuration of the display setting file 172. As shown in FIG. 3, the display setting file 172 stores a category value (entry), commodity code values, additional information entries, and a status information value in association with one another. The additional information may include the commodity image.

In this context, the category value is information indicating a category (classification) in which the commodity will be displayed on a menu, tab, or the like on the operation screen. The category can be set by commodity type or any other indexing value such as “daily special”, “recommendation”, “main”, “side menu”, “drink”, and “dessert”.

The commodity code is the commodity code also registered in the commodity management file 171 but in this context is registered in correlation with a category. Furthermore, the commodity code position in the display setting file 172 may be used to specify the display location of the corresponding operation element and the like for each commodity code on the operation screen. A registration order (list ordering) of commodity codes in the display setting file 172 corresponds to an arrangement order of operation elements within a category display or the like, and the operation elements can be arranged (listed) in the order of the commodity codes in the display setting file 172. In other examples, information about a display layout including such aspects as the arrangement order of the operation elements may be stored as separate data.

In the additional information, information to be added to and displayed on or in conjunction with an operation element of the commodity corresponding to the commodity code is stored. For example, in the additional information, information such as a logo mark related to the commodity can be stored.

In the status information column, information (status information) indicating a state of the commodity corresponding to the commodity code is stored. For example, in the status information entry, information indicating whether a commodity is out of stock, information indicating freshness (such as freshly baked or freshly made), time required for providing the commodity, and the like are stored. In the status information, for example, setting values such as out of stock “no”, freshness “unset”, and standard time required for providing a commodity can be stored as a default state.

Based on the commodity management file 171 and the display setting file 172, the control unit 100 displays, on the display unit 14, an operation screen from which a commodity can be ordered. An operator of the order terminal 10 can order a commodity by selecting the commodity from a plurality of commodities (e.g., menu options) by operating the operation screen displayed on the display unit 14.

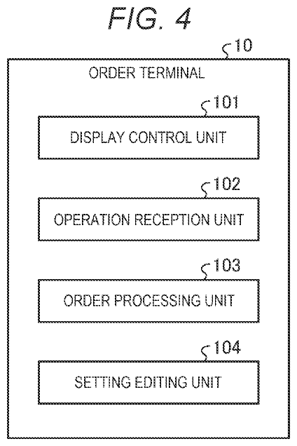

Next, a functional configuration of the order terminal 10 will be described with reference to FIG. 4. FIG. 4 is a diagram showing an example of the functional configuration of the order terminal 10 according to the first embodiment.

As shown in FIG. 4, the order terminal 10 includes a display control unit 101, an operation reception unit 102, an order processing unit 103, and a setting editing unit 104 as functional units.

Specifically, the control unit 100 (CPU 11) of the order terminal 10 implements the above-described functional configuration by executing a program stored in the ROM 12 or the storage unit 17. In the present embodiment, the functional configuration of the order terminal 10 is a software configuration implemented by cooperation between the processor of the order terminal 10 and the program, but is not limited thereto, and, in some examples, may be a hardware configuration in which a part or all of the functional configuration is implemented by a dedicated circuit or the like.

The display control unit 101 is an example of a display control unit. The display control unit 101 controls the display unit 14 to display various screens on the display unit 14. For example, based on the commodity management file 171 and the display setting file 172, the display control unit 101 displays the operation screen on the display unit 14.

The operation reception unit 102 is an example of a first reception unit and a second reception unit. The operation reception unit 102 receives an input operation from the operator by cooperating with the operation unit 15. For example, the operation reception unit 102 receives an operation performed on the operation screen displayed on the display unit 14.

When a commodity to be ordered is selected by an input operation on the operation screen, the order processing unit 103 transmits order information indicating the commodity to an external device. Specifically, the order processing unit 103 generates the order information including a commodity code and a quantity of the ordered commodity, an identification code for identifying the host order terminal 10 of the order processing unit 103, and the like. The order processing unit 103 transmits the generated order information to an external device such as an order management device set in a kitchen or a store server.

Here, an act example of the display control unit 101, the operation reception unit 102, and the order processing unit 103 described above will be described with reference to the operation screen displayed by the display control unit 101.

FIG. 5 is a diagram showing an example of an operation screen G displayed by the display control unit 101 according to the first embodiment. As shown in FIG. 5, the operation screen G includes a first region Ga, a second region Gb, a third region Gc, and a fourth region Gd.

The first region Ga is provided, for example, on top of the operation screen G. In the first region Ga, an operation element such as a drawer menu DR is displayed in addition to information such as an act mode of the order terminal 10, a current date and time, and an identification code with which the order terminal 10 can be identified. Further, an “order” indicating that the order terminal 10 is in an act mode in which a commodity can be ordered (hereinafter, also referred to as an order mode) is displayed in the first region Ga. The order mode is an example of a first act mode.

The second region Gb is provided, for example, below the first region Ga and left to the operation screen G. Operation buttons with which categories can be selected are displayed in the second region Gb. Specifically, for each category registered in the display setting file 172, the display control unit 101 displays an operation button indicating a name of the category in the second region Gb. FIG. 5 shows an example in which category buttons Ba related to six categories including the “daily special”, the “recommendation”, the “main”, the “side menu”, the “drink”, and the “dessert” are displayed in the second region Gb.

The third region Gc is provided, for example, below the first region Ga and adjacent to a right side of the second region Gb. In the third region Gc, commodity selection buttons Bb corresponding to commodity codes correlated with a category selected in the second region Gb are displayed. Here, the commodity selection button Bb is an example of an operation element for selecting a commodity.

Specifically, the display control unit 101 refers to the display setting file 172, and specifies each of the commodity codes correlated with the category selected in the second region Gb. Next, the display control unit 101 reads commodity information (a commodity name, a price, a commodity image, and the like) of the specified commodity code from the commodity management file 171, and generates the commodity selection button Bb indicating the commodity name, the price, the commodity image, and the like for each commodity code. Further, based on the additional information and the status information stored in correlation with the commodity code, the display control unit 101 generates the commodity selection button Bb to which information and an image corresponding to the additional information and the status information are added. The display control unit 101 displays the generated commodity selection button Bb in the third region Gc in the arrangement order set in the display setting file 172.

FIG. 5 shows an example in which the category “recommendation” is selected in the second region Gb, and the commodity selection buttons Bb indicating commodities correlated with the category are disposed in the predetermined arrangement order.

The operator of the order terminal 10 operates (for example, touches) a commodity selection button Bb displayed in the third region Gc, so that the commodity corresponding to the commodity selection button Bb is selected as the order target. When another category is selected from the second region Gb, commodity selection buttons Bb of commodities related to the selected category are displayed in the third region Gc. That is, on the operation screen G, in response to a selection of a category, commodity selection buttons Bb for to the selected category are displayed in the third region Gc.

The fourth region Gd is displayed, for example, below the second region Gb and the third region Gc. A total quantity of ordered items, a total price for the ordered items, and the like can be displayed in the fourth region Gd. Further, a determination button Bc for instructing determination (finalization) of the order is displayed in the fourth region Gd. After the operator of the order terminal 10 confirms the information displayed in the fourth region Gd and decides to actually order the items selected in the third region Gc, the operator touches the determination button Bc.

When the determination button Bc is operated (selected), the order processing unit 103 transmits, to the external device, order information including a commodity code corresponding to the commodity selection button Bb selected in the third region Gc, a quantity, an identification code of the host terminal, and the like.

In this way, in the order terminal 10, by selecting an operation element (a commodity selection button Bb) indicating a commodity displayed on the display unit 14, the commodity to be ordered can be specified and ordered.

It is a common scenario that states of commodities that can be selected on the operation screen G described above change dynamically. For example, depending on a stock of a commodity and an order status of the customer, the commodity may be in an out-of-stock state. Furthermore, for a commodity that requires cooking or other processing before transfer to the customer, there can be a state indicating freshness status such as a freshly baked state or a freshly made state.

The possible states (statuses) of the commodity items described above are displayed on the operation screen G (for example, the third region Gc), so that convenience during the commodity selection can be improved. For example, it is possible to prevent a situation in which an out-of-stock commodity may be selected by clearly indicating the out-of-stock commodity. Further, selection of a commodity in the freshly baked state or the freshly made state can be promoted by clearly indicating the status of an item as a freshly baked or freshly made commodity.

However, in a related-art configuration, in order to reflect the possible states of a commodity as described above on the operation screen G, it is commonly required to directly edit the display setting file 172 by using a dedicated application or terminal such as a manager terminal or the like. Therefore, in the related-art, since time is required for editing the information indicating a state of the commodity (state information or status), for example, the out-of-stock state cannot be quickly reflected, trouble such as the selection of an out-of-stock commodity may occur at an order terminal 10.

Therefore, the order terminal 10 according to the present embodiment includes the setting editing unit 104 for editing the state (s) of a commodity. The setting editing unit 104 is an example of the first reception unit, the second reception unit, and a switching unit. The setting editing unit 104 provides a user interface that allows the editing of information indicating a state of a commodity (state information) by cooperating with the display control unit 101, the operation reception unit 102, and the like.

Specifically, when a predetermined operation is performed while the operation screen G is displayed, the setting editing unit 104 switches the act mode of the order terminal 10 from the order mode to an act mode in which the information indicating the state of the commodity (state information) and the like can be edited (hereinafter, also referred to as an editing mode). In the editing mode, the setting editing unit 104 displays, on the operation screen G, a user interface (GUI) that allows editing of commodity state information and the like by cooperating with the display control unit 101, the operation reception unit 102, and the like. The editing mode is an example of a second act mode.

Hereinafter, an act example of the setting editing unit 104 will be described with reference to the operation screen G. For example, when a predetermined operation is performed on the operation screen G shown in FIG. 5, the setting editing unit 104 switches the act mode of the order terminal 10 to the editing mode.

An operation method for switching from the order mode to the editing mode is not particularly limited, and can be set freely. For example, the setting editing unit 104 may switch to the editing mode on the condition that an operation element such as the category button Ba or the commodity selection button Bb is long pressed for a predetermined time. Further, for example, the setting editing unit 104 may switch to the editing mode on the condition that an operation for switching to the editing mode from the drawer menu DR in the first region Ga is performed.

If the order terminal 10 is self-service, it is preferable to implement restrictions such that only an employee of the store can switch to the editing mode in order to prevent the mode from being carelessly switched to the editing mode by an operation of the customer. For example, the operation method may be complicated such as switching to the editing mode through a plurality of procedures. Further, for example, when switching to the editing mode, verification information such as a predetermined password or an ID of the employee may be input. In this case, the setting editing unit 104 compares the input verification information with information to be verified stored in advance in the storage unit 118 or the like, and switches to the editing mode in a case of coincidence. Further, for example, in a case of the order terminal 10 that can be used by switching between self-service and clerk operated by inputting the verification information when the order terminal 10 is activated, the setting editing unit 104 may switch to the editing mode only when the order terminal 10 acts as a clerk operated terminal.

When the mode is switched to the editing mode, the setting editing unit 104 cooperates with the display control unit 101 to clearly indicate on the operation screen G that an act is performed in the editing mode.

FIG. 6 is a diagram showing an example of the operation screen G displayed by the display control unit 101 according to the first embodiment. Here, FIG. 6 shows an example of the operation screen G displayed in the editing mode.

As shown in FIG. 6, when the order terminal 10 is switched to the editing mode, the operation screen G shows that the order terminal 10 is in the editing mode. For example, “in editing” indicating that the order terminal 10 is in the editing mode is displayed in the first region Ga of the operation screen G. Further, for example, display modes of the commodity selection buttons Bb displayed in the third region Gc are changed. In FIG. 6, the commodity selection buttons Bb are displayed in an inclined state, and display colors of frame lines of the commodity selection buttons Bb are changed.

Accordingly, the operator of the order terminal 10 can easily recognize that the order terminal 10 has shifted to the editing mode by viewing the operation screen G. The display mode used for indicating that the order terminal 10 is in the editing mode is not limited to the example depicted in FIG. 6. For example, shapes of the commodity selection buttons Bb may be changed, or the frame lines of the commodity selection buttons Bb may blink.

In the state illustrated in FIG. 6, a commodity selection button Bb of a commodity that is an editing target can be selected on the operation screen G. Further, it is assumed that if a category is changed by an operation of a category button Ba, as in the order mode, the commodity selection buttons Bb displayed in the third region Gc are updated according to a changed category. That is, on the operation screen G in the editing mode, the commodity that is the editing target can be selected by an operation method similar to that of the order mode.

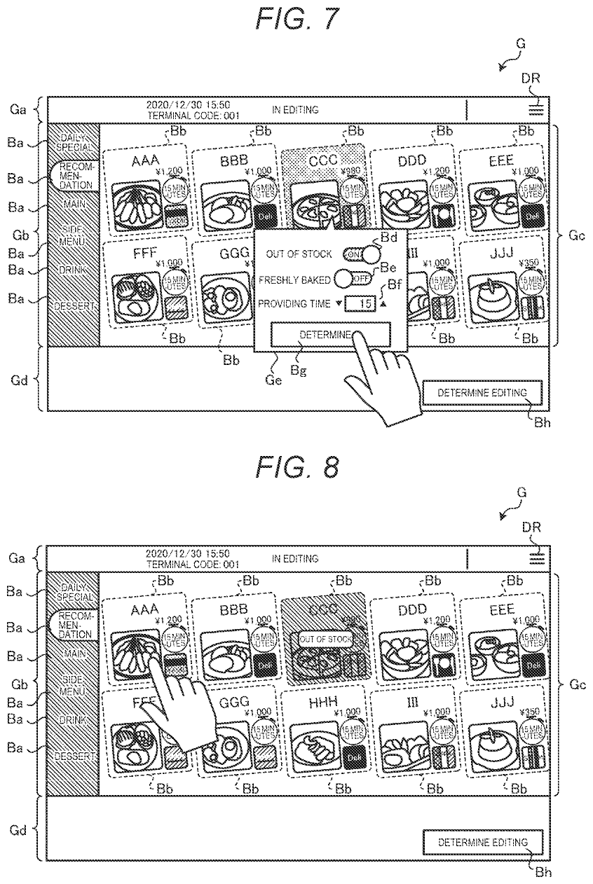

When the commodity that is the editing target is selected by an operation of a commodity selection button Bb, as shown in FIG. 7, the setting editing unit 104 displays an editing screen Ge for supporting the editing operation by cooperating with the display control unit 101.

FIG. 7 is a diagram showing an example of the operation screen G displayed by the display control unit 101 according to the first embodiment. Here, FIG. 7 shows an example of the editing screen Ge displayed when the commodity that is the editing target is selected.

As shown in FIG. 7, the editing screen Ge is displayed, for example, overlapping with the operation screen G (also referred to as overlapped display or pop-up display) in correlation with the commodity selection button Bb of the commodity that is the editing target. In FIG. 7, an example in which a commodity selection button Bb of a commodity name “CCC” is selected is shown, and the editing screen Ge is displayed in correlation with the commodity selection button Bb. The selected commodity selection button Bb of the commodity name “CCC” can be highlighted so as to be identifiable from the other commodity selection buttons Bb.

Operation elements that allow change of the information indicating the state of the commodity (state/status information) and the like are displayed on the editing screen Ge. FIG. 7 shows an example in which a first switching button Bd, a second switching button Be, and a spin button Bf are displayed on the editing screen Ge. The first switching button Bd is for setting whether a commodity is in the out-of-stock state. The second switching button Be is for setting whether a commodity is in the freshly baked state. The spin button Bf is for setting the time required until a commodity can be provided, and the time set via the spin button Bf can be displayed in a region of the commodity selection button Bb in the third region Gc.

The operator of the order terminal 10 can change the information indicating the state of the selected commodity (state information) by operating the editing screen Ge. For example, FIG. 7 shows an example in which the commodity name “CCC” is changed to the out-of-stock state.

It is assumed that the possible setting items displayed on the editing screen Ge are those that can be specified in the status information, but are not limited to the example depicted in FIG. 7. For example, the editable setting items may be changed according to a type or characteristics of the selected commodity. Further, the setting items related to the display of the editing screen Ge may be stored in a separate file. Further, any character string other than the setting items can be input. In this case, for example, the input character string may be displayed overlapping with (displayed in an overlapping manner with) the commodity selection button Bb.

A determination button Bg is provided on the editing screen Ge. When the determination button Bg is operated, the setting editing unit 104 records the edited content set on the editing screen Ge in the status information for a corresponding commodity in the display setting file 172. Specifically, the setting editing unit 104 searches the display setting file 172 for a commodity code corresponding to a commodity selection button Bb and sets the edited content in status information for the commodity code. For example, in the case of FIG. 7, a state indicating “out of stock” is set in status information for the commodity name “CCC” stored in correlation with the category “recommendation”.

The setting editing unit 104 displays the selected commodity selection button Bb in a display mode corresponding to changed state information by cooperating with the display control unit 101. For example, when “out of stock” is set in the state information, as shown in FIG. 8, information indicating the “out of stock” is displayed on the commodity selection button Bb.

Here, FIG. 8 is a diagram showing an example of the operation screen G displayed by the display control unit 101 according to the first embodiment. Here, FIG. 8 shows an example of the editing screen Ge when the “out of stock” state is set. As shown in FIG. 8, when the “out of stock” is set for the commodity name “CCC”, characters or an image indicating the “out of stock” is displayed overlapping with the commodity selection button Bb of the commodity. Further, the commodity selection button Bb is displayed in a grayed-out state. In this case, the setting editing unit 104 cooperates with the operation reception unit 102, and deactivates the selection operation on the commodity selection button Bb of the commodity name “CCC” in the order mode, so that ordering a commodity in the out-of-stock state may be prevented.

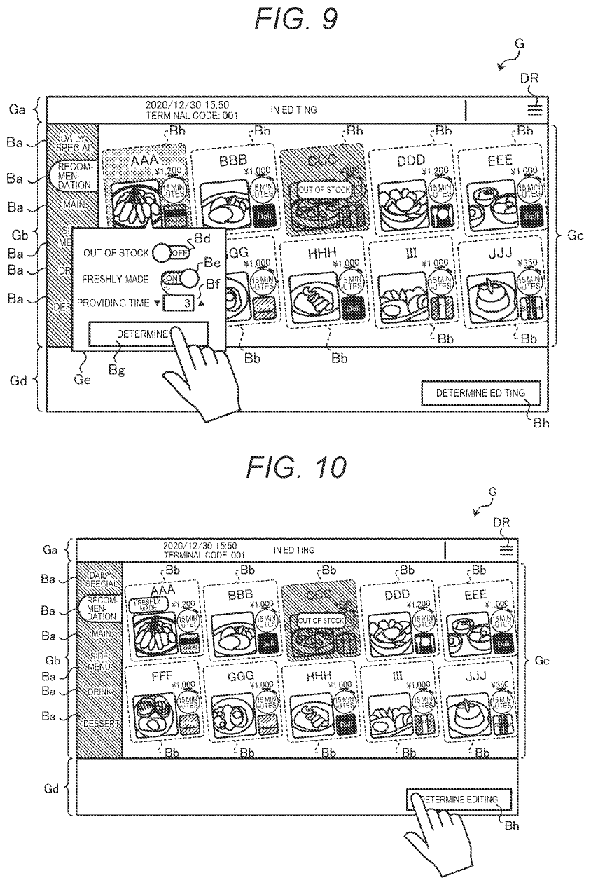

In the state illustrated in FIG. 8, a state of another commodity can also be edited. For example, when a commodity with a commodity name “AAA” is selected as a change target, as shown in FIG. 9, the setting editing unit 104 displays the editing screen Ge in correlation with the commodity of the commodity name “AAA”.

FIG. 9 is a diagram showing an example of the operation screen G displayed by the display control unit 101 according to the first embodiment. Here, FIG. 9 shows an example of the editing screen Ge displayed when the commodity that is the editing target is selected.

As shown in FIG. 9, when the commodity selection button Bb of the commodity name “AAA” is selected, the editing screen Ge is displayed in correlation with the commodity selection button Bb. Here, the setting item of the “freshly made” on the editing screen Ge depicted in FIG. 9 is a setting item similar to that of the “freshly baked” on the editing screen Ge shown in FIG. 7, and is determined by changing words according to a type or characteristics of a selected commodity.

Here, when the determination button Bg is operated after the commodity is set to the “freshly made” state by an operation of the second switching button Be, the setting editing unit 104 records the changed state in status information for the corresponding commodity. As shown in FIG. 10, the setting editing unit 104 displays the selected commodity selection button Bb in a display mode corresponding to the changed state information.

FIG. 10 is a diagram showing an example of the operation screen G displayed by the display control unit 101 according to the first embodiment. Here, FIG. 10 shows an example of the editing screen Ge when the “freshly made” state is set. As shown in FIG. 10, when the “freshly made” state is set for the commodity name “AAA”, information indicating the “freshly made” is added to the commodity selection button Bb of the commodity.

The display of the information indicating the “freshly made” or the like added to the commodity selection button Bb may be automatically canceled as time elapses. For example, an elapsed time since “freshly made” was first displayed can be automatically measured, and the display can be canceled regardless of the operation of an operator once a predetermined time (for example, 20 minutes) elapses. Accordingly, it is possible to avoid the trouble that the freshly made state is not appropriately canceled and thus displayed even though the state (status) cannot be appropriately considered freshly made.

The 20 minutes serving as the time until the automatic cancellation is an example, and it is desirable that a value in consideration of a change as time elapses is determined for each commodity. Setting of the time until the automatic cancellation may be performed by predetermining a fixed value, or setting of the value may be received on the editing screen Ge shown in FIGS. 7 and 9 or another screen. In the former case, a method of setting the value together with the setting for “freshly baked” or “freshly made” can be considered. In the latter case, for example, a method can be considered in which when the second switching button Be related to the setting item of the “freshly made” is operated on the editing screen Ge shown in FIG. 9, a pop-up window that receives an input of the time until the cancellation is further displayed. Of course, the time until the automatic cancellation may be set by any method.

Further, a case of a commodity with a limited quantity will be described as another example related to the automatic cancellation. For example, in a case of a commodity having a limited saleable quantity such as “limited to 50 pieces”, every time an order is received, a countdown of subtracting a received order quantity from a limited quantity (“50” in this example) may be performed, and the commodity may be switched to the “out of stock” status when the limited quantity becomes “0”.

The above case will be described in more detail. First, in the case of the commodity having a limited saleable quantity, the information is displayed on the commodity selection button Bb. That is, the display control unit 101 additionally displays words such as “limited to 50 pieces” by overlapping with the commodity selection button Bb. As in an example of “freshly made”, the words can be determined according to the type or characteristics of the relevant commodity. Further, the processing of displaying the words is as follows.

First, as in a case of the setting item of the “freshly made” on the editing screen Ge of FIG. 9, “limited to n pieces” is displayed on the editing screen Ge as a selection item that can be set by an operation of the second switching button Be. When a commodity is set in the “limited to n pieces” state by the operation of the second switching button Be, next, an input of a numerical value to be applied to “n” is received by, for example, the pop-up window as described above. The input of the numerical value may be performed by, for example, changing a value by using up and down keys, or making a selection from selection options.

Next, when the determination button Bg is operated, the setting editing unit 104 records a changed state in status information for a corresponding commodity. The setting editing unit 104 displays the selected commodity selection button Bb in a display mode corresponding to the changed status information.

Thereafter, every time an order for the commodity is received, the control unit 100 of the order terminal 10 performs a countdown and subtracts a received order quantity from the limited quantity. When the limited quantity becomes “0” by this countdown, the control unit 100 causes the setting editing unit 104 to record the “out of stock” state in the status information for the corresponding commodity. The setting editing unit 104 displays the selected commodity selection button Bb in a display mode corresponding to the changed state information.

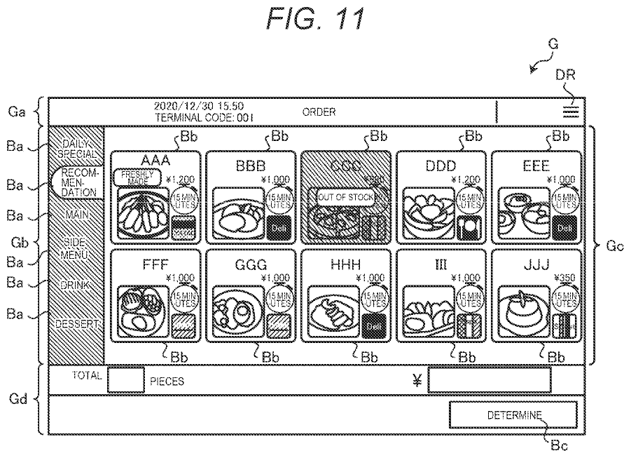

In the editing mode, an editing determination button Bh is displayed in the fourth region Gd. The editing determination button Bh is an operation element for instructing the end of the editing mode. When the editing determination button Bh is operated, the setting editing unit 104 switches from the editing mode to the order mode. For example, after the editing determination button Bh is operated in the state illustrated in FIG. 10, the operation screen G of the order mode in which the display of the act mode of the first region Ga, the inclination of the commodity selection buttons Bb, and the like are returned to normal and displayed as shown in FIG. 11.

FIG. 11 is a diagram showing an example of the operation screen G displayed by the display control unit 101 according to the first embodiment. Here, FIG. 11 shows an example of the editing screen Ge in a state of returning from the editing mode to the order mode. As shown in FIG. 11, the commodity selection buttons Bb related to the commodities of the commodity names “AAA” and “CCC” and edited in the editing mode are displayed in a display mode corresponding to the edited setting content as in FIG. 10. That is, the states of the commodities edited in the editing mode are maintained even after the mode is shifted to the order mode.

In this way, the order terminal 10 according to the first embodiment provides an interface that enables easy editing of the setting related to the display of the commodity selection button Bb by using the operation screen G used for ordering a commodity as it is. Accordingly, when a state such as out of stock occurs, the operator of the order terminal 10 can quickly reflect the state in the commodity selection button Bb for the corresponding commodity. Further, since the operator of the order terminal 10 can perform the setting edits related to the display of the commodity selection button Bb by using the operation screen G, which is also used for ordering the commodity, the commodity ordering and the state editing can be performed seamlessly. Therefore, the operator of the order terminal 10 can easily perform the editing of settings related to the display of the commodity selection button Bb.

In the present embodiment, the edited content is reflected in the display setting file 172 on the condition that the determination button Bg on the editing screen Ge is operated, but the exemplary embodiment is not limited thereto. For example, the setting editing unit 104 may, on the condition that the editing determination button Bh is operated, reflect the edited content of the commodities edited by the previous operation at once in the display setting file 172.

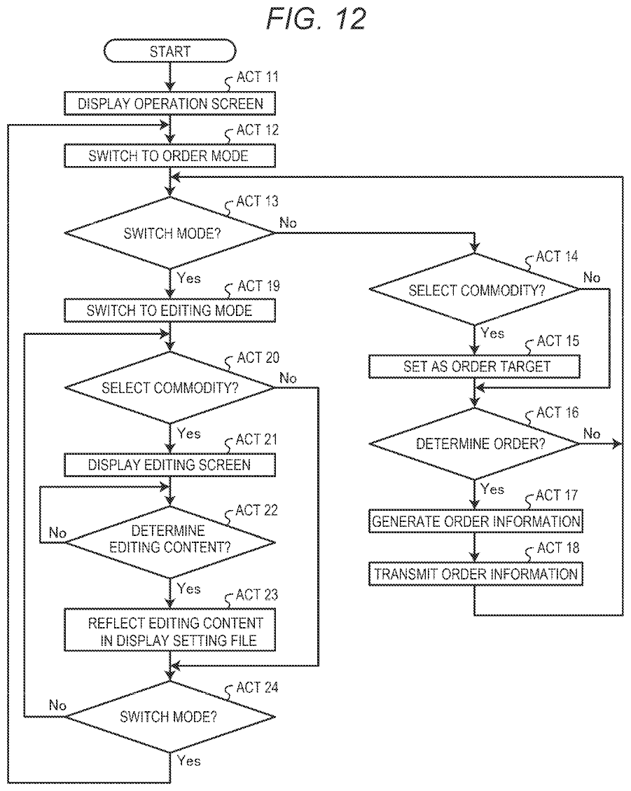

Hereinafter, an example of processing performed by the order terminal 10 will be described with reference to FIG. 12. FIG. 12 is a flowchart showing the example of the processing performed by the order terminal 10 according to the first embodiment.

First, as a premise of the present processing, it is assumed that the operation screen G is displayed on the display unit 14 of the order terminal 10 (Act S11). Further, it is assumed that the order terminal 10 is initially in the order mode (Act S12).

The operation reception unit 102 determines whether a switching operation for switching to the editing mode is received (Act S13). If the switching operation is not received in Act S13 (No in Act S13), the operation reception unit 102 is shifted to Act S14.

In Act S14, the operation reception unit 102 determines whether a selection operation of a commodity is received via the commodity selection button Bb (Act S14). If the operation reception unit 102 does not receive the selection operation (No in Act S14), the processing is shifted to Act S16. Further, if the operation reception unit 102 receives the selection operation of the commodity (Yes in Act S14), the order processing unit 103 sets the selected commodity as an order target (Act S15).

Next, the operation reception unit 102 determines whether a determination operation for determining an order has been performed (Act S16). If the operation reception unit 102 does not receive the determination operation (No in Act S16), the processing is returned to Act S13.

If the operation reception unit 102 receives the determination operation for the order (Yes in Act S16), the order processing unit 103 generates order information based on a commodity code and the like of the commodities set as the order target by the processing so far (Act S17). The order processing unit 103 transmits the generated order information to the external device (Act S18), and returns the processing to Act S13. If no commodity has been set as an order target when the determination operation is received, the order processing unit 103 returns the processing to Act S13 without shifting to Act S17.

If the operation reception unit 102 receives a switching to the editing mode in Act S13 (Yes in Act S13), the setting editing unit 104 switches the order terminal 10 to the editing mode (Act S19).

Next, the operation reception unit 102 determines whether the selection operation of a commodity has been received via the commodity selection button Bb (Act S20). If the operation reception unit 102 does not receive the selection operation for a commodity (No in Act S20), the processing is shifted to Act S24. If the operation reception unit 102 receives the selection operation of a commodity (Yes in Act S20), the setting editing unit 104 displays the editing screen Ge in correlation with the selected commodity (Act S21).

Here, the operator of the order terminal 10 can change settings such as a state of the commodity via the editing screen Ge displayed in Act S21. The setting editing unit 104 waits until the operation reception unit 102 receives a determination operation for instructing the finalization (determination) of a setting change (No in Act S22). If the operation reception unit 102 receives a determination operation (Yes in Act S22), the setting editing unit 104 reflects the changed setting content in the display setting file 172 (Act S23). Accordingly, a commodity selection button Bb that now reflects the edited setting content will be displayed on the operation screen G.

Next, the setting editing unit 104 determines whether the operation reception unit 102 receives a mode switching operation for instructing the end of the editing mode (Act S24). Here, if the operation reception unit 102 does not receive the mode switching operation (No in Act S24), the setting editing unit 104 returns the processing to Act S20. If the operation reception unit 102 receives the mode switching operation (Yes in Act S24), the setting editing unit 104 returns the active mode of the order terminal 10 to the order mode by returning the processing to Act S12.

As described above, the order terminal 10 displays, on the display unit 14, the operation screen G on which commodity selection buttons Bb corresponding to a plurality of commodities are disposed, and receives a selection operation for a commodity via the corresponding commodity selection button Bb. When in the order mode, the order terminal 10 executes the processing related to the ordering of the commodity based on the commodity selected via the commodity selection button Bb, and when in the editing mode, the order terminal 10 can receives the editing operations for the settings related to the state of the commodity corresponding to the selected commodity selection button Bb. The order terminal 10 changes the display mode of the commodity selection button Bb displayed on the operation screen G according to the content of the editing operation.

Accordingly, if a state of a commodity is to be changed, the operator of the order terminal 10 can edit settings related to display of a commodity selection button Bb by using the operation screen G and the commodity selection button Bb used for ordering the commodity. Therefore, in the order terminal 10, the settings related to the display of the commodity selection buttons Bb can be easily edited, and an edited state can be quickly reflected in the commodity selection button Bb.

As described above, it is possible to provide an information processing apparatus and a program that enables easy editing of settings related to display of an operation element used for selecting (ordering) a commodity. According to the information processing apparatus provided by the first embodiment, an out-of-stock commodity can be clearly indicated. Accordingly, a situation in which the out-of-stock commodity may still be selected can be prevented. Further, a freshly baked or freshly made commodity can be clearly indicated. Accordingly, selection of a freshly baked or freshly made commodity can be promoted, thereby contributing to sales promotion.

### Second Embodiment

In the first embodiment, a configuration is described in which the state (status) of a commodity can be edited with the single order terminal 10. However, in a mode of operation in which a plurality of order terminals 10 are used in the same store, the status edits (changes) to a commodity made at one order terminal 10 may also be preferably applied to the other order terminals 10. For example, if a commodity is out of stock, it is appropriate to prevent all order terminals 10 from accepting orders for the commodity.

Therefore, in the second embodiment, a configuration will be described in which a state of a commodity set by one order terminal 10 can be reflected in other order terminals 10. Constituent elements similar to those in the first embodiment are denoted by the same reference numerals, and description thereof will be omitted.

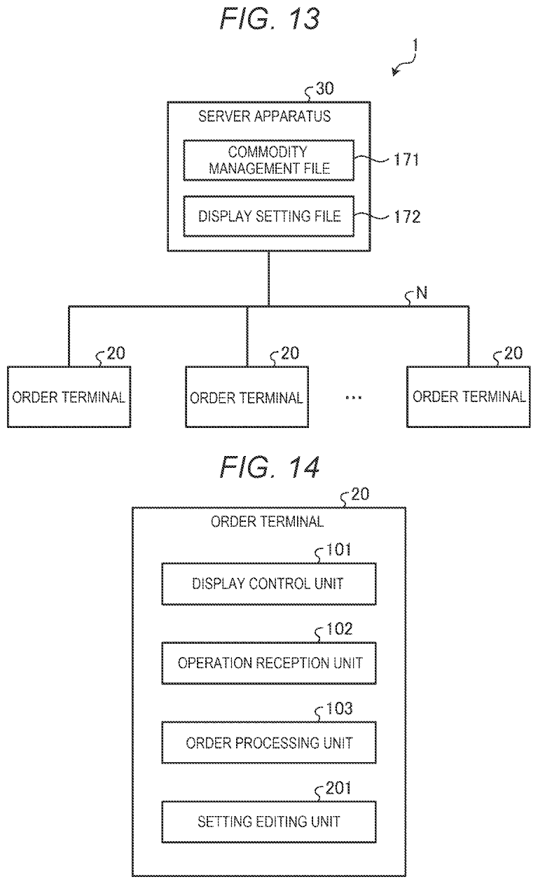

FIG. 13 is a diagram showing an example of a configuration of an information processing system according to the second embodiment. As shown in FIG. 13, an information processing system 1 includes a plurality of order terminals 20 and a server apparatus 30. The order terminals 20 and the server apparatus 30 are communicably connected to each other via a network N such as a local area network (LAN).

The order terminal 20 corresponds to the order terminal 10 according to the embodiment described above, and includes a hardware configuration similar to that of the order terminal 10.

The server apparatus 30 is, for example, a server apparatus such as a store server, and includes a computer configuration similar to that of the order terminal 10. Further, the server apparatus 30 stores and manages the commodity management file 171 and the display setting file 172 in a storage device such as an HDD.

The commodity management file 171 and the display setting file 172 stored by the server apparatus 30 are, for example, basic information of the commodity management file 171 and the display setting file 172 stored by each of the order terminals 20, and distributed to all of the order terminals 20 via the network N. In this case, the control unit 100 of the order terminal 20 receives the commodity management file 171 and the display setting file 172 as distributed from the server apparatus 30, and stores the commodity management file 171 and the display setting file 172 in the storage unit 17. Hereinafter, the display setting file 172 stored by the server apparatus 30 is also referred to as a “master” or “master file.”

FIG. 14 is a diagram showing an example of a functional configuration of the order terminal 20 according to the second embodiment. As shown in FIG. 14, the order terminal 20 includes the display control unit 101, the operation reception unit 102, the order processing unit 103, and a setting editing unit 201 as functional units.

Specifically, the control unit 100 of the order terminal 20 implements the above-described functional configuration by executing a program stored in the ROM 12 or the storage unit 17. In the second embodiment, the functional configuration of the order terminal 20 is a software configuration implemented by cooperation between a processor of the order terminal 20 and a program, but is not limited thereto, and, in other examples, may be a hardware configuration in which a part or all of the functional configuration is implemented as a dedicated circuit or the like.

The setting editing unit 201 is a functional unit corresponding to the setting editing unit 104 and has a function similar to that of the setting editing unit 104. Further, the setting editing unit 201 is an example of a reflection unit, and when a state of a commodity is edited from the operation screen G, executes processing for reflecting edited content thereof in the master of the server apparatus 30.

Specifically, when the state of the commodity is changed in the editing mode, and the setting editing unit 201 is instructed to reflect the edited content thereof in the master of the server apparatus 30, the setting editing unit 201 notifies the server apparatus 30 of a category and a commodity code of the edited commodity and setting content of an edited item.

When notified of the edited content from the order terminal 20, the control unit of the server apparatus 30 implemented by the computer configuration of the server apparatus 30 searches the display setting file 172 for the commodity of the category and the commodity code instructed in the edited content. Further, the control unit of the server apparatus 30 records the setting content of the item instructed in the edited content in status information for the commodity.

When the display setting file 172 is updated, the control unit of the server apparatus 30 distributes the updated display setting file 172 to the order terminals 20. The control unit of the server apparatus 30 may distribute the updated display setting file 172 to the remaining order terminals 20 other than the order terminal 20 that sent the edited content. Further, the control unit of the server apparatus 30 might only distribute difference data corresponding to just the updated part of the display setting file 172. In this case, at the order terminal 20 that receives the difference data (update), the setting editing unit 201 (or the control unit 100) updates the display setting file 172 based on the difference data so that the status of the commodity as edited at another order terminal 20 is reflected in the host order terminal 20.

In this way, in the information processing system 1, a status of a commodity that has been edited by one order terminal 20 is reflected in other order terminals 20. Accordingly, when a commodity becomes out of stock, if the corresponding commodity is set and changed to an out-of-stock state by one order terminal 20, the edited content thereof will be reflected in the other order terminals 20, and the operation screens G can be synchronized across all the order terminals 20.

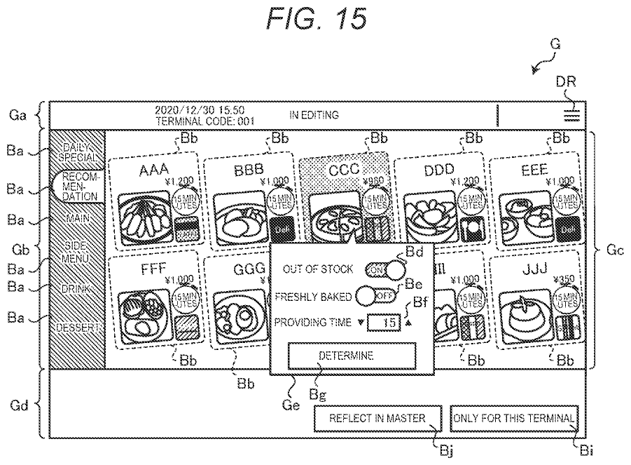

When instructed to reflect edited content in the master, the setting editing unit 201 may record the edited content for the edited commodity in the master. In this case, for example, the operation screen G shown in FIG. 15 may be used to confirm with the operator whether to record the edited content in the master.

FIG. 15 is a diagram showing an example of the operation screen G displayed by the display control unit 101 according to the second embodiment. Here, FIG. 15 shows an example of the operation screen G displayed in the editing mode.

As shown in FIG. 15, the operation screen G includes the first region Ga, the second region Gb, the third region Gc, and the fourth region Gd as in the embodiment described above. Further, on the operation screen G in the editing mode, by selecting a commodity selection button Bb displayed in the third region Gc, the editing screen Ge is displayed as in the embodiment described above. FIG. 15 shows a state where a commodity selection button of the commodity name “CCC” is selected.

In the fourth region Gd, a first button Bi for instructing that edited content (changes) set on the editing screen Ge to be recorded only locally at the terminal and a second button Bj for instructing the edited content to be recorded in the master are displayed.

Here, when the first button Bi is operated, the setting editing unit 201 switches an act mode of the order terminal 10 to the order mode. That is, when the first button Bi is operated, since the setting editing unit 201 does not notify the server apparatus 30 of the edited content, the edited content is set to be limited to the host order terminal 20.

On the other hand, when the second button Bj is operated, the setting editing unit 201 notifies the server apparatus 30 of the edited content, and then switches the act mode of the order terminal 10 to the order mode. That is, when the second button Bj is operated, since the setting editing unit 201 notifies the server apparatus 30 of the edited content, the edited content set by the host order terminal 20 will also be reflected at other order terminals 20.

In this way, convenience can be improved by making it possible to select whether to record the edited content set at the order terminal 20 in the master, that is, to reflect the edited content in the other order terminals 20.

In the present embodiment, the content edited at one order terminal 20 is reflected in the other order terminals 20 via the server apparatus 30, but the exemplary embodiment is not limited thereto. For example, the setting editing unit 201 of the order terminal 20 where the editing operation is performed may directly notify other order terminals 20 of the edited content thereof to reflect the edited content in other order terminals 20.

In this case, the setting editing units 201 on another order terminal 20 that receive the notification of the content update the display setting files 172 locally stored in the storage units 17 based on the notified edited content. Accordingly, a status of a commodity as edited by one order terminal 20 can be reflected in the other order terminals 20.

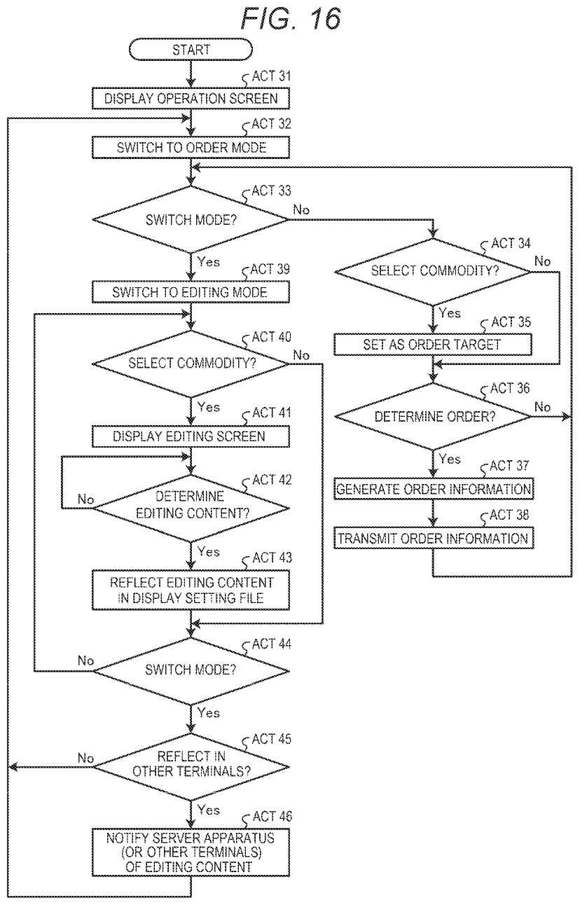

Next, an example of processing performed by the order terminal 20 according to the second embodiment will be described with reference to FIG. 16. FIG. 16 is a flowchart showing an example of the processing performed by the order terminal 20 according to the second embodiment. Since Acts S31 to S44 in FIG. 16 are substantially similar to Acts S11 to S23 described for FIG. 12, additional description thereof will be omitted.

If the operation reception unit 102 receives a mode switching operation in Act S44 (Yes in Act S44), the setting editing unit 201 determines whether the operation reception unit 102 further receives an instruction to reflect edited content in other order terminals 20 (Act S45). Here, if the operation reception unit 102 does not receive the instruction to reflect the edited content in other order terminals 20 (No in Act S45), the setting editing unit 201 returns the processing to Act S32.

On the other hand, if the operation reception unit 102 receives the instruction to reflect the edited content in other order terminals 20 (Yes in Act S45), the setting editing unit 201 notifies the server apparatus 30 or other order terminals 20 of the edited content, and reflects the edited content in other order terminals 20 (Act S46). The setting editing unit 201 returns the processing to Act S32.

As described above, the order terminal 20 according to the present embodiment includes the configuration similar to that of the order terminal 10 according to the embodiment described above, and enables reflection of the content of the editing operation received on the operation screen G in other order terminals 20 by indirectly notifying other order terminals 20 via the server apparatus 30 or directly notifying other order terminals 20.

Accordingly, in a store where the plurality of order terminals 20 are used, effects of the embodiment described above can be achieved, the content of the editing operation performed by one order terminal 20 can be reflected in other order terminals 20, and therefore the convenience can be improved.

As described according the present above, to embodiment, a state of a commodity set by one order terminal 10 can also be reflected in other order terminals 10. For example, in an operating mode in which a plurality of order terminals 10 are used in the same store, a state of a commodity edited by one order terminal 10 can also be applied to other order terminals 10. Accordingly, for example, if a commodity becomes out of stock, processing related to reflection on an order screen for disabling ordering the out-of-stock commodity on all the order terminals 10 can be performed with an extremely small number of steps as compared with a related-art configuration. Therefore, stopping order reception of the out-of-stock commodity in the order terminal 10 can be quickly completed. Therefore, it is possible to prevent occurrences of trouble due to an order of the out-of-stock commodity being input.

Each embodiment described above can be modified and implemented by changing a part of the configuration or the function of each apparatus described above. Therefore, in the following description, some modifications will be described as additional embodiments. In the following description, parts different from those of the embodiments already described above will be mainly described, and detailed description of parts common to those of already described content will be omitted. Further, the modifications described below may be implemented individually or in combination as appropriate.

### First Modification

In the embodiments described above, an example applied to the order terminal 10 that orders a commodity is described, but the applications are not limited thereto. For example, the present disclosure can be applied to a commodity sales data processing apparatus such as a POS terminal used in a retailer such as a supermarket, a convenience store, and the like.

Generally, in a commodity sales data processing apparatus, a commodity code that enables identification of a commodity is read from a code symbol such as a bar code attached to the commodity, and registration processing for registering a commodity to be purchased by a customer is performed based on the commodity code. Furthermore, in the commodity sales data processing apparatus, commodity selection buttons corresponding to a plurality of commodities sold in a store are disposed on an operation screen, and a commodity selected via a commodity selection button is registered.

In this case, the operation screen is displayed based on, for example, files similar to the commodity management file 171 and the display setting file 172 described above. Further, the commodity sales data processing apparatus stores at least the display setting file 172 in the host terminal.

When the present disclosure is applied to a commodity sales data processing apparatus, the commodity sales data processing apparatus may include the display control unit 101, the operation reception unit 102, and the setting editing unit 104 as described above as functional units. Further, in this case, the functional units of the commodity sales data processing apparatus for registering a commodity selected via a commodity selection button instead of using the order processing unit 103 are examples of processing units.

For example, in a mass retailer, a commodity may be in an out-of-stock state depending on sales or a stock status of the commodity. Further, prepared dishes and the like may be sold after being cooked, and it is useful to indicate freshness such as “freshly made”. Further, in a convenience store, fast food may be sold near a counter where the POS terminal is placed. In such a case, as in the embodiments described above, the operation screen can be displayed in the editing mode, and setting related to a state of a corresponding commodity edited, so that the state of the commodity can be easily reflected in a commodity selection button.

The present disclosure can also be applied to any apparatus other than a commodity sales data processing apparatus as long as the apparatus performs a registration of a commodity by using an operation screen or the like. For example, in recent years, the registration of the commodity has been performed using a smartphone or a tablet terminal, and the present disclosure can also be applied to these apparatuses. Further, the exemplary embodiments can also be applied to an apparatus that executes processing other than ordering and registration on a commodity selected via the operation screen.

### Second Modification

In the embodiments described above, a setting related to the state (status) of a commodity can be edited using an operation screen G. However, the editing targets are not limited thereto.

For example, content set in the additional information may be editable.

Display modes (manner of display) of the commodity selection buttons Bb on the operation screen G may be editable. For example, an editing operation related to the display modes of the commodity selection buttons Bb such as an operation of editing (changing) the arrangement order of the commodity selection buttons Bb, or an operation of hiding or deleting a commodity selection button Bb may be receivable on the operation screen G when in the editing mode.

For example, when the operation of changing the arrangement order of the commodity selection buttons Bb is performed, the setting editing unit 104 changes a registration order of records related to corresponding commodity codes in the display setting file 172 according to the changed arrangement order of the commodity selection buttons Bb. In this way, a layout of the commodity selection buttons Bb displayed on the operation screen G can be updated.

For example, when the editing operation of hiding a commodity selection button Bb is performed, the setting editing unit 104 performs control such that a particular commodity selection button Bb will not be displayed on the operation screen G changing a setting for hiding (non-display) in the state information related to the corresponding commodity code of the commodity selection button Bb. In this case, for a commodity code set to be hidden, the display control unit 101 may perform control such that the commodity selection button Bb is not displayed (omitted) or may display a blank region having a size equivalent to that of the commodity selection button Bb instead of using the particular commodity selection button Bb that has been hidden. If an act is performed in the editing mode for hiding a commodity selection button Bb, it is preferable that the set state can be visually recognized by displaying information such as “in hiding setting” or “set to hidden” on the commodity selection button Bb for the commodity code (s) set to be hidden. Accordingly, the hiding setting can be canceled easily at a later point.

For example, when the editing operation of deleting a commodity selection button Bb is performed, the setting editing unit 104 performs control such that the commodity selection button Bb that is the operation target is not displayed on the operation screen G by deleting, from the display setting file 172, the data entry related to the commodity code of the commodity selection button Bb.

When the editing operation related to the display mode of the commodity selection button Bb is performed, if content edited at one order terminal 10 is carelessly or unintentionally reflected in the other order terminals 10 (or the order terminals 20), operators of the other order terminals 10 may be confused.

Therefore, the setting editing units 104 (or the setting editing units 201) on another order terminal 10 that receives the notification of the edited content may display confirmation screens for confirming whether the edited content should be used, and then record the edited content in the local display setting file 172 only when instructed to do so. Further, in this case, it is preferable that information indicating the edited content (update) is displayed on the confirmation screen in a manner to promote the understanding of the operator of the possible update.

A program executed by each apparatus according to the embodiments described above can be provided by being incorporated in advance in the ROM, the storage unit, or the like. The program executed by each apparatus according to the embodiments described above may be provided by being recorded in a non-transitory, computer-readable recording medium such as a CD-ROM, a flexible disk (FD), a CD-R, or a digital versatile disk (DVD) as a file having an installable format or an executable format.

Further, the program executed by each apparatus according to the embodiments described above may be stored in a computer connected to a network such as the Internet, and provided by being downloaded via the network. Further, the program executed by each apparatus according to the embodiments described above may be accessed or distributed via the network such as the Internet.

While the embodiments described herein are explained above, the embodiments are presented by way of examples only, and are not intended to limit the scope of the exemplary embodiments. The novel embodiments and modifications thereof can be implemented in various other modes, and various omissions, replacements, changes, and combinations can be made in a scope not departing from the gist of the exemplary embodiments. The embodiments and modifications thereof are included in the scope and the gist of the exemplary embodiments described herein, and are also included in the exemplary embodiments described in the claims and equivalents thereof.

What is claimed is:

1. An information processing apparatus, comprising:
a storage unit;
a communication interface; and
a processor configured to:
cause a display screen to display an operation screen on which operation elements corresponding to a plurality of items are disposed;
receive a selection of an operation element displayed on the operation screen;
execute order processing based on the received selection of the operation element if the processor is in a first operating mode; and
receive an editing operation for changing setting information related to a state of the item corresponding to the selected operation element if the processor is in a second operating mode, wherein
a display mode of the selected operation element is set according to the setting information related to the state of the item.

2. The information processing apparatus according to claim 1, wherein processor is further configured to:
switch between the first and second operating modes upon receiving a predetermined operation on the operation screen.

3. The information processing apparatus according to claim 1, wherein the operation screen visually identifies whether a present operating mode is the first operating mode or the second operating mode.

4. The information processing apparatus according to claim 1, wherein the processor is further configured to:
record the setting information as changed by the editing operation in the storage unit.

5. The information processing apparatus according to claim 4, wherein the processor is further configured to:
send the setting information as changed by the editing operation to an external apparatus via the communication interface.

6. The information processing apparatus according to claim 1, wherein the processor is further configured to:
send the setting information as changed by the editing operation to an external apparatus via the communication interface.

7. The information processing apparatus according to claim 1, wherein the processor is further configured to:
record the setting information as changed by the editing operation in the storage unit;
display a confirmation operation element on the display screen after receiving the editing operation; and
send the setting information as changed by the editing operation to an external apparatus via the communication interface based on an operation of the confirmation operation element.

8. The information processing apparatus according to claim 1, wherein the setting information related to a state of the item includes a stock level of the item corresponding to the selected operation element.

9. The information processing apparatus according to claim 1, wherein the setting information related to a state of the item includes a freshness state of the item corresponding to the selected operation element.

10. An ordering system, comprising:
a server apparatus storing a display setting master file including display settings for operation elements corresponding to a plurality of items; and
a plurality of ordering terminals, each ordering terminal including:
a storage unit;
a communication interface connected to the server apparatus; and
a processor configured to:
cause a display screen to display an operation screen on which operation elements corresponding to the plurality of items are disposed;
receive a selection of an operation element displayed on the operation screen;
execute order processing based on the received selection of the operation element if the processor is in a first operating mode; and
receive an editing operation for changing setting information related to a state of the item corresponding to the selected operation element if the processor is in a second operating mode, wherein
a display mode of the selected operation element is set according to the setting information related to the state of the item.

11. The ordering system according to claim 10, wherein each processor is further configured to:
record the setting information as changed by the editing operation in a local display setting file in the storage unit, the local display setting file including the display settings for operation elements corresponding to the plurality of items.

12. The ordering system according to claim 11, wherein each processor is further configured to:
send the setting information as changed by the editing operation to the server apparatus via the communication interface.

13. The ordering system according to claim 10, wherein each processor is further configured to:
send the setting changed by the editing operation to the server apparatus via the communication interface.

14. The ordering system according to claim 10, wherein each processor is further configured to:
record the setting information as changed by the editing operation in a local display setting file in the storage unit;
display a confirmation operation element on the display screen after receiving the editing operation; and
send the setting information as changed by the editing operation to the server apparatus via the communication interface based on an operation of the confirmation operation element.

15. An information processing method for an ordering terminal, the method comprising:
causing a display screen of the ordering terminal to display an operation screen on which operation elements corresponding to a plurality of items are disposed;
receiving a user selection of an operation element displayed on the operation screen;
executing order processing based on the received selection of the operation element if the ordering terminal is in a first operating mode; and
receiving an editing operation for changing setting information related to a state of the item corresponding to the selected operation element if the ordering terminal is in a second operating mode, wherein
a display mode of the selected operation element is set according to the setting information related to the state of the item.

16. The information processing method according to claim 15, further comprising:
switching between the first and second operating modes upon receiving a predetermined operation on the operation screen.

17. The information processing method according to claim 15, wherein the operation screen visually identifies whether a present operating mode is the first operating mode or the second operating mode.

18. The information processing method according to claim 15, further comprising:
recording the setting information as changed by the editing operation in a storage unit of the ordering terminal.

19. The information processing method according to claim 18, further comprising:
sending the setting information as changed by the editing operation to an external apparatus via a communication interface of the ordering terminal.

20. The information processing method according to claim 15, further comprising:
recording the setting information as changed by the editing operation in a storage unit of the ordering terminal;
displaying a confirmation operation element on the display screen after receiving the editing operation; and
sending the setting information as changed by the editing operation to an external apparatus via a communication interface or the ordering terminal based on an operation of the confirmation operation element.
